(19) United States
(12) Patent Application Publication
(10) Pub. No.: US 2008/0288471 A1
(43) Pub. Date: Nov. 20, 2008

(54) APPARATUS AND METHOD FOR PROVIDING A DATA MARKETPLACE

(75) Inventors: Ju Wu, Coquitlam (CA); Santiago Becerra, SR., Del Mar, CA (US); Jaime Zuluaga, Fremont, CA (US); Stephen Petschulat, Coquitlam (CA); Je Kwang Lee, Burnaby (CA)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/750,993

(22) Filed: May 18, 2007

(51) Int. Cl. G06F 17/30

(52) U.S. Cl. 707/4

(57) ABSTRACT

A computer readable storage medium includes executable instructions to provide an online store for displaying enhanced data presentation entities. Each enhanced data presentation entity has associated data values from a specified data source. Instructions to purchase a selected enhanced data presentation entity are received. The selected enhanced data presentation entity specifies a number of versions of data. An identification is assigned to the selected enhanced data presentation entity. The selected enhanced data presentation entity and associated data values are presented to a user.

### BRIEF DESCRIPTION OF THE INVENTION

This invention relates generally to digital data storage and retrieval. More particularly, this invention relates to techniques to establish a data marketplace to browse and select disparate data packages.

### BACKGROUND OF THE INVENTION

Various technologies support the purchase of data in a networked environment. The data is made available in various forms. For example, one can download a report for a fee, one can access a web site for a subscription fee, or one can receive broadcast emails for a subscription fee. In each of these manifestations, the content is pre-packaged and is provided to each user in the same pre-packaged form.

It would be desirable to provide a data marketplace in which an individual could select data in various volumes, where the data is presented in accordance with selected visualizations. This would allow a user to purchase tailored data that is more suitable for an individual's budget and comprehension.

### SUMMARY OF THE INVENTION

The invention includes a computer readable storage medium with executable instructions to provide an online store for displaying enhanced data presentation entities. Each enhanced data presentation entity has associated data values from a specified data source. Instructions to purchase a selected enhanced data presentation entity are received. The selected enhanced data presentation entity specifies a number of versions of data. An identification is assigned to the selected enhanced data presentation entity. The selected enhanced data presentation entity and associated data values are presented to a user.

The invention also includes a computer readable storage medium with executable instructions to present data packages, where each data package specifies a data source, data visualization information, data frequency, and data package price. A selected data package is identified. Delivery of data associated with the selected data package is coordinated.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates a marketplace graphical user interface (GUI) utilized in accordance with an embodiment of the invention.

FIG. 4 illustrates a marketplace GUI utilized in accordance with another embodiment of the invention.

FIG. 5 illustrates another marketplace GUI utilized in accordance with an embodiment of the invention.

Like reference numerals refer to corresponding parts throughout the several views of the drawings.

### DETAILED DESCRIPTION OF THE INVENTION

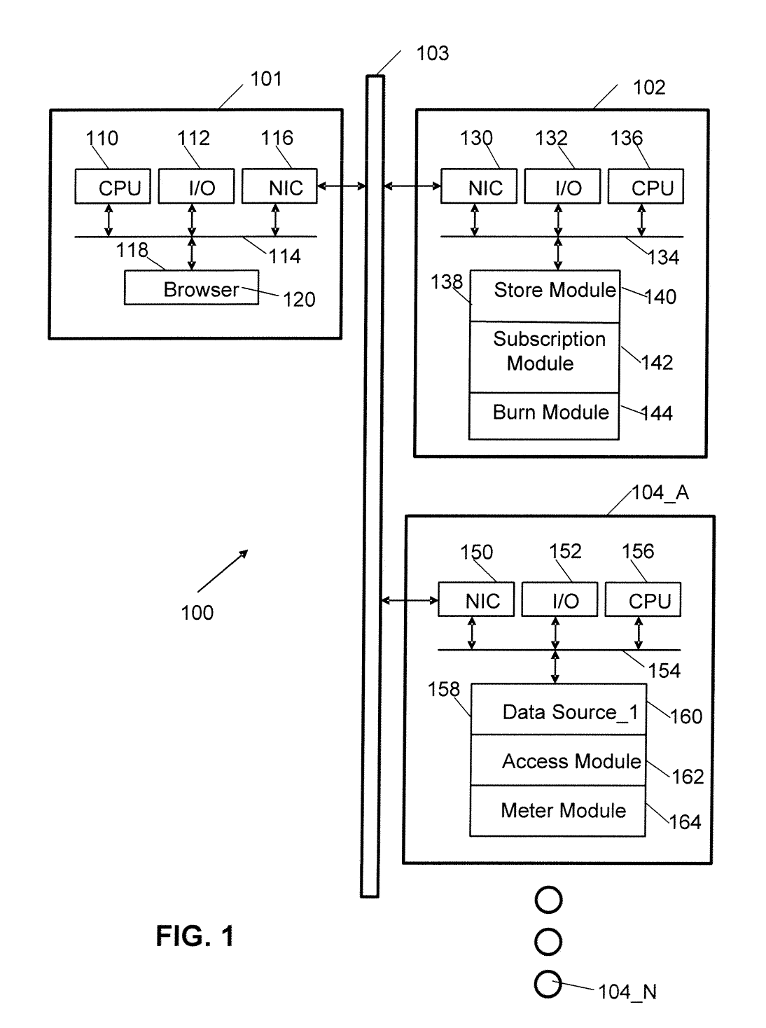

FIG. 1 illustrates a system 100 configured in accordance with an embodiment of the invention. The system 100 includes a client computer 101 connected to a server computer 102 via a communication link 103, which may be any wired or wireless communication medium. The client computer 101 includes standard components, such as a central processing unit 110 connected to a set of input output devices 112 via a bus 114. The input/output devices 112 may include a keyboard, mouse, touchpad, monitor, printer and the like. Also connected to the bus 114 is a network interface card 116, which provides network connectivity. A memory 118 is also connected to the bus 114. The memory 118 stores a standard browser 120. The client computer 101 may be a personal digital assistant, mobile telephone, or other portable device. Regardless of the configuration, the client computer 101 is operative to access a data marketplace to allow a user to secure information tailored to the user's interests.

The system 100 also includes a server computer 102. The server computer 102 includes standard components, such as a network interface card 130, which is connected to a central processing unit 136 via a bus 134. Input/output devices 132 are also connected to the bus 134. A memory 138 is also connected to the bus 134. The memory 138 stores executable instructions to implement operations associated with the invention. For example, the memory 138 may include a store module 140, which includes executable instructions to allow one to define and display an Enhanced Data Presentation Entity (EDPE). Each EDPE is linked to a data source and provides a visualization of a sub-set of information associated with the data source. Further, each EDPE has an associated control that specifies the frequency at which data is received. The frequency may be a single download. Alternately, the frequency may provide for an unlimited number of data updates in a specified time period. Alternately, the frequency may specify a specific number of data updates over any given time. The EDPE operates to link to a data source, filter selected information from the data source and present that information in a specified visualization.

An EDPE provides data within a complex presentation format. The complex presentation format can include a report document type format, an analytic format, or another interactive widget type presentation of the data. The EDPE specifies how to access data and format it. An EDPE where the content does not include external data, either saved within the EDPE or accessed live, is an EDPE template rather than an EDPE. Unlike, other non-EDPE documents that may optionally import external data within a document, an EDPE by design is primarily a medium for accessing, formatting, transforming and or presenting external data.

An EDPE is specifically designed to facilitate working with external data sources. In addition to information regarding external data source connection drivers and subscription privileges, the EDPE may specify advanced filtering of data, information for combining data from different external data sources, information for updating join structures and relationships in EDPE data, and instructions including logic to support a more complex internal data model (that may include additional constraints, relationships, and metadata).

The EDPE may specify logic for accepting user input. User input may be accepted initially when customizing an EDPE template by adding a specific data selection, filter, warning threshold, or other attribute. The EDPE may specify logic for accepting user input after the EDPE has been generated with data, such as adding custom values to an interactive EDPE. The custom values that are added can include specific data selection, filters, specific values for “what if” projections, and the like. User input may also specify drill-up and drill-down operations.

In contrast to a spreadsheet type or simple charting application, an EDPE generation tool is generally not limited to a table structure but can support a range of structures, such as sections, cross-tables, synchronized tables, sub-reports, hybrid charts, and the like. A spreadsheet or simple charting application applies a spatial logic that is based on the location of the data within the layout of the spreadsheet or chart in order to interpret data and perform calculations on the data. In contrast, an EDPE design tool is not limited to logic that is based on the display of the data, but rather can interpret the data and perform calculations based on the original (or a redefined) data structure and meaning of the imported data. The EDPE may also interpret the data and perform calculations based on pre-existing relationships between elements of imported data. An EDPE can support a range of calculation models.

Memory 138 also stores a subscription module 142. The subscription module 142 includes executable instructions to manage the selection and delivery of data selected by a user. The memory 138 also stores a burn module 144, which includes executable instructions to assign a persistent identification to an EDPE, allowing the EDPE to be used across various platforms.

The system 100 may also includes a set of data sources 104_A through 104_N. By way of example, the data sources 104 may be a web service, file system, data warehouse and the like. Each data source 104 typically includes standard components, such as a network interface circuit 150, input/output devices 152, and a central processing unity 156 linked by a bus 154. A memory 158 is also connected to the bus 154. In this example, the memory 158 includes a data source 160 that may be accessed by a user. An access module 162 includes executable instructions to facilitate network access to the data source 160. A meter module 164 includes executable instructions to measure the amount of data delivered to the user. The meter module 164 is configured to process the frequency information associated with an EDPE so that a user receives the amount of data specified by the frequency information.

The configuration of system 100 is exemplary. Data sources may be associated with the server 102 and multiple data sources may be combined in server 104_A. The various modules in computer 102 may be utilized on computer 104 and vice versa. It is the operations of the invention that are significant, not the particular manner or location where those operations are performed.

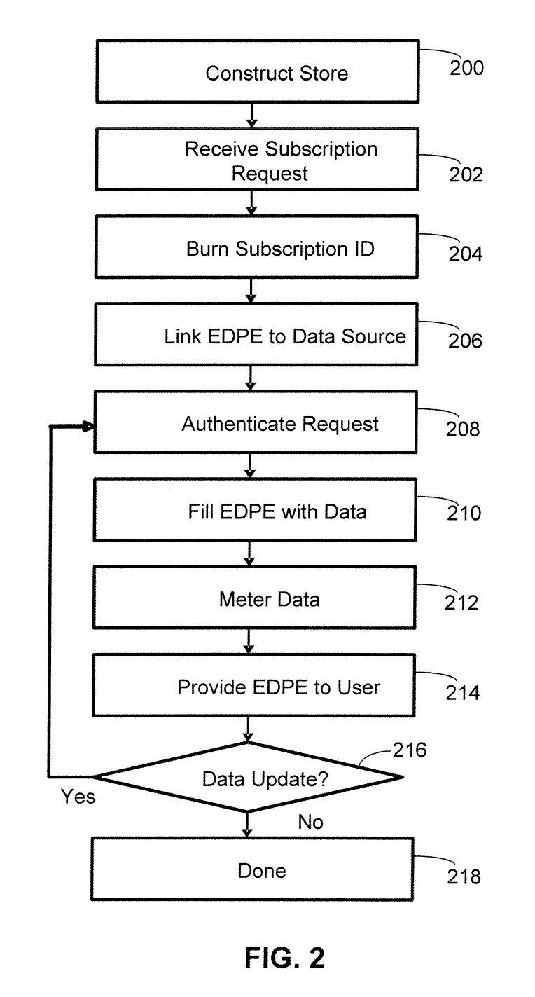

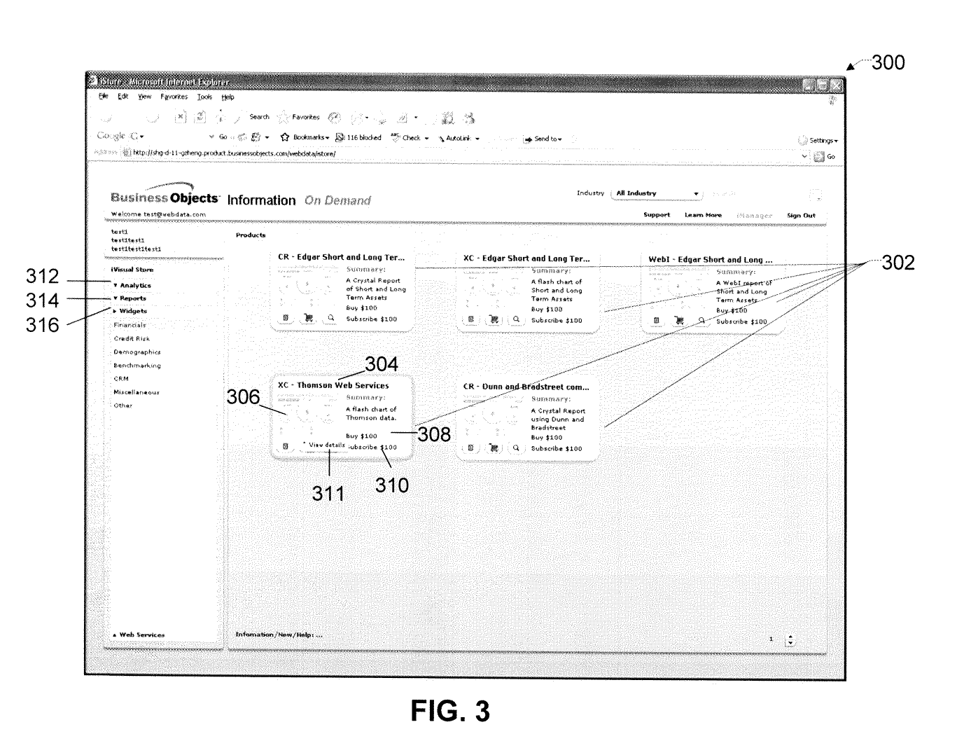

FIG. 2 illustrates processing operations associated with an embodiment of the invention. Initially, a store is constructed 200. A store or marketplace may be constructed using the store module 140. FIG. 3 illustrates a marketplace GUI 300 that is supplied by the store module 140 to a browser 120 of a client 101. The GUI 300 includes a set of EDPEs 302. Each EDPE includes data source information 304. The data source information may be specified as a Uniform Resource Locator (URL) link, a specified file in a file system, a sub-set of information in a data warehouse, and the like. In addition, each EDPE includes data visualization information 306. Typically, the data visualization information includes a dashboard, chart, plot or other mechanism to display data in a static or dynamic manner. Each EDPE also includes a data package price 308. Further, each EDPE includes a data frequency option 310, in this case a subscription to provide data on a periodic basis. A details button 311 may be used to provide additional information on the EDPE. The GUI 300 displays various product EDPEs. Other classes of EDPEs may also be used, such as analytics 312, reports 314, widgets 316, and the like.

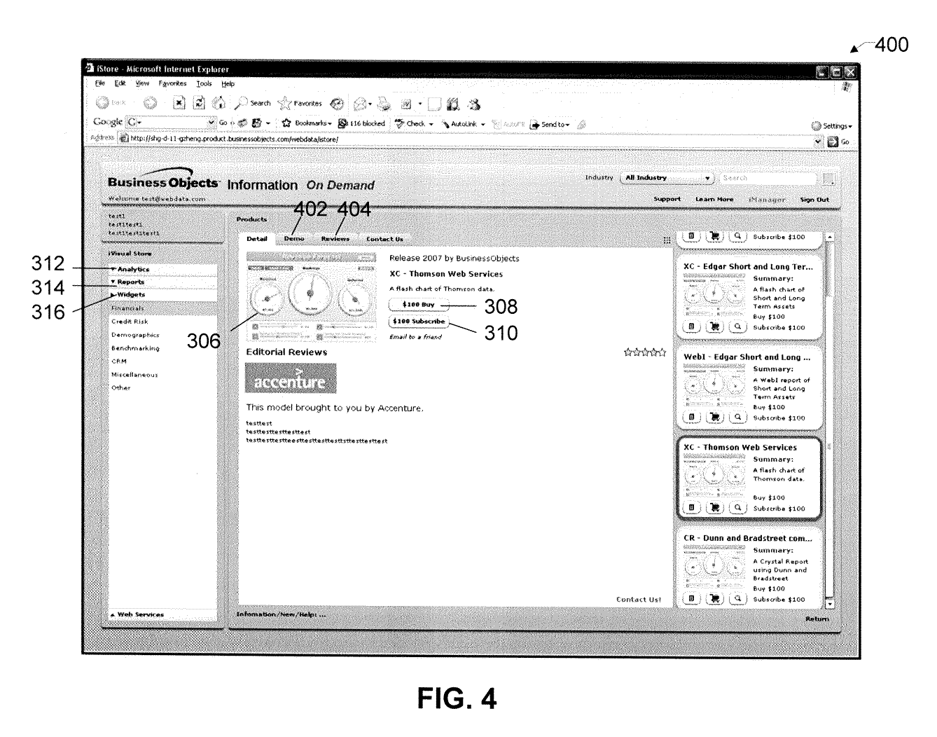

Returning to FIG. 2, the next processing operation is to receive a subscription request 202. For example, a subscription request may be received at the server 102 from a user accessing the server from client 101. FIG. 4 illustrates a GUI 400 that may be used to receive a subscription request. The GUI 400 is invoked by pressing the view details button 311. The GUI 400 includes components illustrated in FIG. 3, but also includes access to demos 402 and reviews 404. Pressing buttons 308 and 310 in GUI 300 or GUI 400 results in a subscription request. In the case of button 308, the subscription request is a single report or document presented with the visualization 306. In the case of button 310, the subscription request is a series of documents presented with the visualization 306. The subscription module 142 may be used to process the subscription request.

The next processing operation of FIG. 2 is to burn a subscription identification into the requested EDPE. The burn module 144 may be used to implement this operation. The burn module 144 ascribes a persistent identification to the requested EDPE The burn module 144 passes this identification to any data source associated with the EDPE. The data source may then use the identification and other authentication information (e.g., username and password) to authenticate a request for information.

The EDPE is then linked to a data source 206. For example, the subscription module 142 may send the selected EDPE to the data source to initiate the retrieval of the requested information. The EDPE is then authenticated 208. Authentication is typically performed at the data source. For example, the access module 162 may be used to process the persistent identification and other authentication information. In one embodiment, the access module 162 looks up the subscription identification in the subscription module 142. In response to this operation, the subscription module 142 provides parameters associated with the subscription to the access module 162. These parameters are subsequently used by the access module 162 to access the appropriate data from the data source 160.

The subscription module 142 may also communicate with the access module 162 to coordinate revenue sharing associated with the purchase of the data associated with the EDPE. For example, the subscription module 142 may include executable instructions to process a credit card payment for data. The subscription module 142 may then keep a facilitation fee, while providing a payment to the data source.

The next processing operation of FIG. 2 is to fill the EDPE with data 210. Recall that the EDPE specifies a presentation format. The presentation format effectively filters data at the data source (e.g., using the retrieved parameters) so that only the requested information is provided. The data passed by the data source is metered 212. The meter module 164 may be used to quantify the passed data in accordance with the request. The EDPE is then provided to the user 214. For example, the access module 162 passes the EDPE to the client 101.

At this point, if the EDPE does not include updates (212—NO), processing is complete. Otherwise, if the EDPE includes updates, processing is returned to block 208. The processing of blocks 208-216 is repeated until all updates are received. For example, the downloaded EDPE may be configured to receive an unlimited number of updates over a specified period of time. Alternately, the EDPE may be configured to receive a specified number of updates over any given period of time. In one embodiment, updates may be secured for different parameters. For example, if an initial report supplies information on one company, then an update may provide information for a second company.

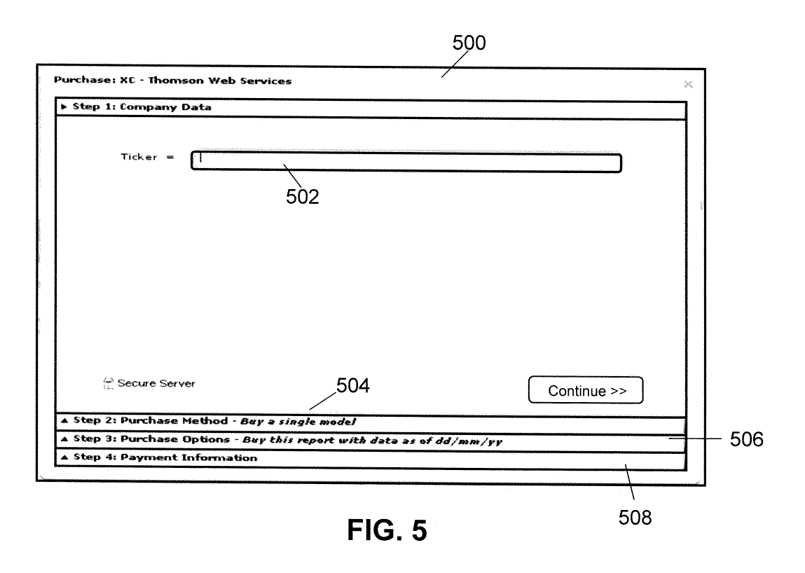

FIG. 5 illustrates an alternate GUI 500 that may be utilized in accordance with an embodiment of the invention. The GUI 500 includes a block 502 to specify a company financial ticker symbol. A user may enter the symbol to receive an EDPE and associated data for the specified company. GUI 500 also includes a block 504 to specify the frequency of information, for example, a single instance or multiple instances of the EDPE and associated data. Other purchase options may be specified in block 506. For example, the purchase option may be a function of date. A payment block 508 is also supplied in the GUI 500. In this example, a data source contains information on multiple companies, but the EDPE specifies information for one or more companies, resulting in information being fetched only for those one or more companies.

Those skilled in the art will recognize a number of advantages associated with the disclosed technology. For example, an EDPE may be constructed to provide useful visualizations and data package sizes (e.g., a single download, periodic downloads, a subset of source information, etc.). Attributes of a single EDPE may be used in connection with a number of data sources, potentially operated by different entities. Therefore, an EDPE developer may facilitate access to a variety of data sources. Similarly, multiple EDPEs may be associated with a single data source.

The invention provides a data marketplace in which an individual can select data in various volumes in accordance with selected visualizations. This allows a user to purchase tailored data that is more suitable for an individual's budget and comprehension.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
present a plurality of data packages, wherein each data package specifies:
a data source,
data visualization information,
data frequency, and
data package price;
identify a selected data package; and
coordinate delivery of data associated with the selected data package.

2. The computer readable storage medium of claim 1 further comprising executable instructions to assign a persistent identification with the selected data package.

3. The computer readable storage medium of claim 1 further comprising executable instructions to meter data access for the selected data package.

4. The computer readable storage medium of claim 1 wherein the data source is a selected from a web service, a file system and a data warehouse.

5. The computer readable storage medium of claim 1 wherein a plurality of data packages are associated with a single data source, with each data package having a unique attribute selected from data visualization information, data frequency and data package price.

6. The computer readable storage medium of claim 1 wherein the data frequency specifies a number of data installments.

7. The computer readable storage medium of claim 1 wherein the executable instructions to coordinate include executable instructions to coordinate download of a data model.

8. The computer readable storage medium of claim 7 wherein the data model includes executable instructions to update a subset of data values at the data source.

9. A computer readable storage medium, comprising executable instructions to:
provide an online store for displaying enhanced data presentation entities, wherein each enhanced data presentation entity has associated data values from a specified data source;
receive instructions to purchase a selected enhanced data presentation entity, wherein the selected enhanced data presentation entity specifies a number of versions of data;
assign an identification with the selected enhanced data presentation entity; and
provide the selected enhanced data presentation entity and associated data values to a user.

10. The computer readable storage medium of claim 9 wherein the executable instructions to assign include executable instructions to assign a persistent identification.

11. The computer readable storage medium of claim 9 further comprising executable instructions to meter data access for the selected enhanced data presentation entity.

12. The computer readable storage medium of claim 9 wherein the selected enhanced data presentation entity specifies a data source and a subset of data within the data source.

13. The computer readable storage medium of claim 12 wherein the data source is selected from a web service, a file system and a data warehouse.

14. The computer readable storage medium of claim 9 wherein the selected enhanced data presentation entity includes executable instructions to update selected data values associated with the specified data source.

15. The computer readable storage medium of claim 9 wherein the enhanced data presentation entities include data visualization information.

16. The computer readable storage medium of claim 9 wherein the enhanced data presentation entities have associated prices.

17. The computer readable storage medium of claim 16 further comprising executable instructions to process payment for the selected enhanced data presentation entity.
